(19) United States
(12) Patent Application Publication
(10) Pub. No.: US 2006/0174074 A1
(43) Pub. Date: Aug. 3, 2006

(54) Point-in-time copy operation

(75) Inventors: Mohammad Banikazemi, New York, NY (US); Dan E. Poff, Mahopac, NY (US)

Correspondence Address: FREDERICK W. GIBB, III;GIBB INTELLECTUAL PROPERTY LAW FIRM, LLC, 2568-A RIVA ROAD, SUITE 304, ANNAPOLIS, MD, 21401, US

(73) Assignee: International Business Machines Corporation, Armonk, NY (US)

(21) Appl. No.: 11/050,239

(22) Filed: Feb. 3, 2005

(51) Int. Cl. G06F 12/16

(52) U.S. Cl. 711/162

(57) ABSTRACT

A method and service creates and maintains a virtual point-in-time copy of source data stored within a source storage unit. The method/service receives at least one request to create a point-in-time copy of the source data. However, instead of creating a copy of the source data, the invention creates a target storage unit mapping table within a target storage unit or other storage units managed by the same storage system. This target storage unit mapping table contains pointers to the source data. In addition, the invention maintains a modification space within the target storage unit or other storage units managed by the same storage system. Each portion of the modification space is associated with a given target storage unit. The modification space only stores changes to the source data that are unique to the corresponding target storage unit. The target storage unit mapping table is modified as the data is written to the modification space by redirecting corresponding pointers in the target storage unit mapping table from the source data to the modification space.

### BACKGROUND OF THE INVENTION

1. Field of the Invention

The present invention relates to a method for creating a point-in-time copy of computer system data stored in a data storage arrangement of a microcomputer system. In particular, the present invention describes methods for creating space and time efficient copies of one or more volumes of interest with minimal resources and easy to implement software algorithms.

2. Description of the Related Art

Conventional systems that utilize point-in-time copies, copy the original or source disk or logical unit (LUN) to one or more copy instances (also called target disks or target LUNs) without physically copying data and by setting up control data structures (metadata) such that a block on a target LUN refers to the corresponding block on the source LUN. Then, only when one or more blocks on the source LUN are modified and/or written to, these blocks need to be copied. In conventional systems, these blocks are copied into all copy instances before they are modified on the source LUN. This puts a limit on how many point-in-time copies (e.g., 4) of a LUN can be made. This approach has the advantage that if a block is not modified, it is stored only in one place (called space efficient copy). In addition to performance related benefits, this can lead to a better caching performance, as disk blocks on different disks or LUNs refer to the same disk blocks and therefore may occupy less space in cache memory. In another approach, each target LUN requires as much disk space as the source LUN and even when a large percentage of disk blocks are only read, they are stored in each copy. This physical copy from source to target LUNs is usually performed as a background process. This type of point-in-time copy operation does not lead to good copying and caching performance. Therefore, there is a need for an improved system and method for copying source data.

### SUMMARY OF THE INVENTION

Embodiments herein include a method and service of creating and maintaining a virtual point-in-time copy of source data stored within a source storage unit or a source LUN. The method/service receives at least one request to create a point-in-time copy of the source data. However, instead of creating a copy of the source data, the invention creates a target storage unit or LUN mapping table which is stored within the target storage unit or other storage space managed by the same storage system. This target storage unit mapping table contains pointers to the source data. In addition, the invention maintains a modification space within the storage system. Each portion of the modification space is associated with a given target LUN. The modification space for a target LUN only stores changes to the source data that are unique to that target LUN. The target storage unit mapping table is modified as the data is written to the modification space by redirecting corresponding pointers in the target storage unit mapping table from the source data to the modification space.

As long as a virtual copy of the source data is in existence, the method marks the source storage LUN as a source volume. When the source storage LUN is marked as a source volume, it cannot be modified. Instead, only the target storage unit mapping table pointers and corresponding modification are allowed to be changed. Target storage units can be deleted over time. If no target storage units refer to the source storage unit, the invention marks the source storage unit as a regular volume. When the source storage unit is marked as a regular volume, it can be modified. Making the source volumes read only makes it possible to have several copy instances without any compromise in the performance. Furthermore, this requirement makes this point-in-time copy method easy to implement as each target LUN needs to manage a modification space.

Embodiments herein also include a computer system for maintaining a virtual point-in-time copy of source data. The system comprises a source storage unit or LUN with physical storage device(s) and a source storage unit mapping table. The source storage unit mapping table maintains pointers to the source data within the source storage unit and is stored in the source storage device or in other storage devices managed by the same storage system. Target storage unit(s) also called target LUNs are also included in the system. These target storage units include a target storage unit mapping table that maintains pointers to the source data within the source storage unit and pointers to modification data stored within the modification area. The entries in target storage unit mapping table point to same data blocks as those pointed to in the source storage unit mapping table except where pointers in the target storage unit mapping table point to the modification data in place of corresponding source data.

Over time, the target storage unit mapping table maintains a unique virtual copy of the source data through a unique combination of pointers that point to portions of the source data and portions of the modification space. These pointers can comprise direct pointers or indirect pointers. Modification space is used to maintain the modification data. It is part of the target storage unit or special space on the storage system dedicated for this purpose. A list of free blocks of storage within the storage system lists the blocks that are available to be used as the modification space. The source storage unit mapping table includes pointers to locations on the physical storage device within the source storage unit. The source storage unit mapping table and the target storage unit mapping table can be mapping tables of pointers, mapping tables of flags, or a linked list with hashing tables.

Source data is maintained in source storage units or source LUNS. The source storage unit mapping table is maintained in either a target storage unit or target LUN, or other storage units managed by the same storage system. A target storage unit mapping table is maintained in either a target storage unit or target LUN, or other storage units managed by the same storage system. Modification space is maintained within either a target storage unit or target LUN, or other storage units managed by the same storage system.

These, and other, aspects and objects of the present invention will be better appreciated and understood when considered in conjunction with the following description and the accompanying drawings. It should be understood, however, that the following description, while indicating preferred embodiments of the present invention and numerous specific details thereof, is given by way of illustration and not of limitation. Many changes and modifications may be made within the scope of the present invention without departing from the spirit thereof, and the invention includes all such modifications.

### BRIEF DESCRIPTION OF THE DRAWINGS

The invention will be better understood from the following detailed description with reference to the drawings, in which:

FIG. 1 is a schematic diagram that shows an example of the system of interest for the present invention;

FIG. 2 is a schematic diagram that shows one instance of a system with three point-in-time copies of one volume;

FIG. 3 is a schematic diagram that shows a system with segregated free space management after one block in one copy volume is written to; and

FIG. 4 shows the flow diagram of an embodiment of the invention.

### DETAILED DESCRIPTION OF PREFERRED EMBODIMENTS OF THE INVENTION

The present invention and the various features and advantageous details thereof are explained more fully with reference to the nonlimiting embodiments that are illustrated in the accompanying drawings and detailed in the following description. It should be noted that the features illustrated in the drawings are not necessarily drawn to scale. Descriptions of well-known components and processing techniques are omitted so as to not unnecessarily obscure the present invention. The examples used herein are intended merely to facilitate an understanding of ways in which the invention may be practiced and to further enable those of skill in the art to practice the invention. Accordingly, the examples should not be construed as limiting the scope of the invention.

The invention described below provides a new copy methodology/service/system which is particularly suitable for server provisioning via point-in-time copy on storage controllers. Instead of creating a copy of the source data, the invention creates a target storage unit mapping table. This target storage unit mapping table contains pointers to the source data. In addition, the invention maintains a modification space within the storage system. Each portion of the modification space is associated with a given target storage unit or target LUN. The modification space only stores changes to the source data that are unique to the corresponding target LUN. The target storage unit mapping table is modified as the data is written to the modification space by redirecting corresponding pointers in the target storage unit mapping table from the source data to the modification space. Over time, the target storage unit mapping table maintains a unique virtual copy of the source data through a unique combination of pointers that point to portions of the source data and portions of the modification space.

With the invention, when a logical disk becomes the source of a copy operation, it will automatically become read only. This requirement allows the system to provide a larger number of copies while maintaining high performance. Furthermore, since the original copy is read only, all disk blocks which have not been modified are stored on disk once and when accessed by multiple nodes accessing different copies, only one copy can be stored in the storage management cache. This operation is very suitable for provisioning when a golden disk containing the image of an operating system is created and multiple (tens) copies are created as needed.

One or more storage units, also called Logical Units or LUNs, can be used as the source of space and time efficient point-in-time copy operation. The operation is time efficient as it does not require the physical copying of source data blocks into another storage area and therefore it does not require a long period of time to be performed. The time required for performing the operation is mainly spent on creating and maintaining relatively small data structures through which user requests can be directed into correct locations in storage devices. The operation presented in the present invention is also space efficient because a data block is physically copied to new locations only when it changes and, therefore, the amount of physical storage used for keeping the point-in-time copies is minimal. The space for source data is essentially the size of the source LUN which can be huge. The point is that there is not control over the size of the source. For the target, as long as there are not many modified blocks, the space is very limited. So the size of the target will depend on the amount of modified blocks. While this disclosure discuss embodiments for creating a point-in-time copy of one LUN, as would be understood by those ordinarily skilled in the art, a similar approach can be used for performing such an operation on multiple LUNs as a single operation.

When a point-in-time copy of a source LUN is requested, the invention establishes a data structure (e.g., a mapping table) for the target LUN such that, for each logical unit, pointers to the original source data are maintained. In an embodiment, the mapping table is implemented as a table of pointers and possibly other flags. In another embodiment, the mapping table is implemented as a linked list with hashing tables.

The entries in mapping tables are first initialized such that they point directly to the physical location of the corresponding block of the source LUN. In another embodiment where indirect pointers are used, the pointers point to entries in the similar data structure for the source LUN. Entries for the source LUN contain the information regarding where a data block is actually stored on physical devices.

A certain amount of storage space, called modification space, is set aside in the physical storage devices of the target LUN or other storage units managed by the storage system performing the copy operation for each point-in-time copy. The size of this storage space is set by the creator of the copy operation in one embodiment. In another embodiment, the size of the modification space is determined by the storage system software or administrator. The modification space is used when a logical unit or block of the copy LUN is modified. A data structure which contains a list of free blocks in this modification space is kept for each copy LUN.

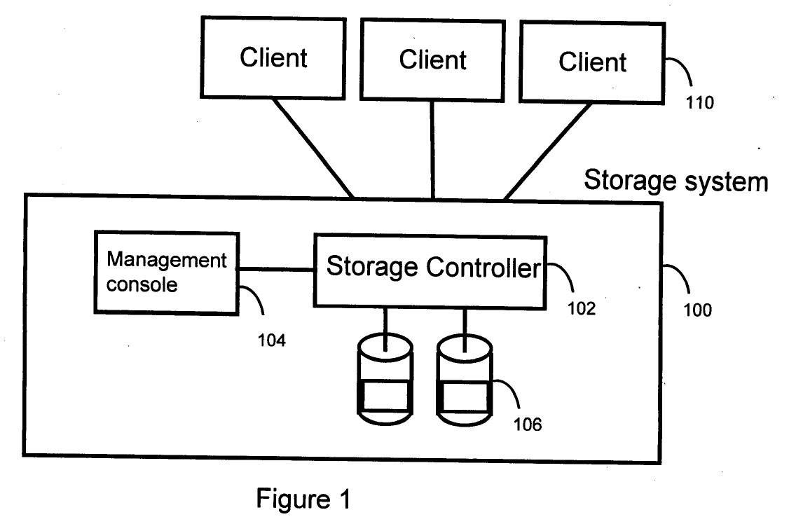

FIG. 1 shows a system of interest where one or more client microcomputer systems (110) are connected to a storage system (100). The storage system is made of a control unit called storage controller (102), possibly a management console (104) which may or may not be an integrated pad of the storage system, and one or more physical storage devices (106) such as hard disks.

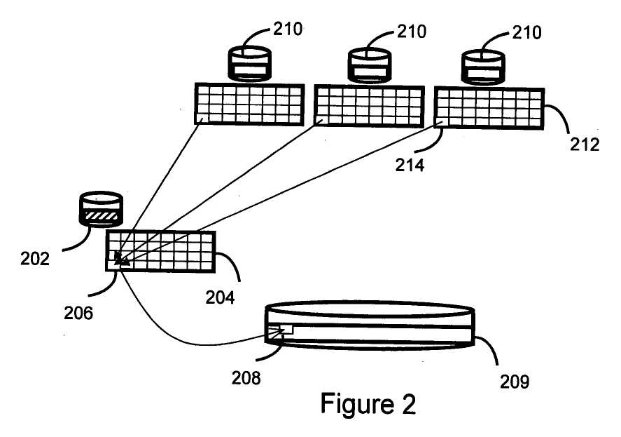

FIG. 2 shows a system where three point-in-time copies (210) (also called target volumes or LUNs) of one source LUN (202) (also called source LUN or source storage unit) are created. All LUNs (including source LUN and target LUNs) have their own mapping tables (204, 212). After initialization of point-in-time copies, each entry in the mapping table of target LUNs point to the corresponding entry in the source volume. One such entry is shown in FIG. 2 (206, 214). The entry for each block in the source mapping table points to the location of the block (208) on the physical storage (209) which can be made of one or more hard disk drives. It should be noted that, alternatively, target mapping tables could be created by copying the content of the source mapping table. In such a case, entries in target mapping tables are direct pointers which point to the block on the physical storage.

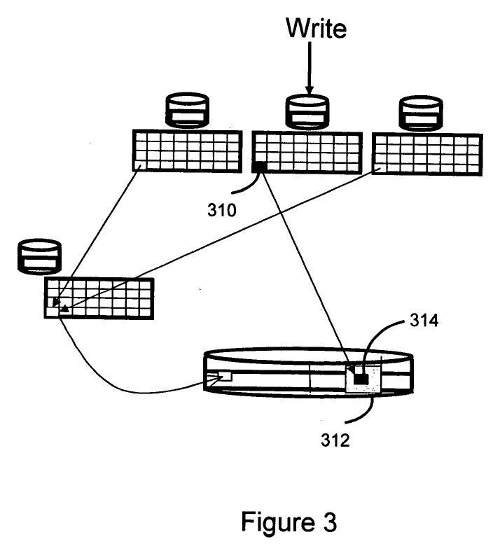

FIG. 3 shows the inventive system where one block in one of the copy volumes is modified. As shown, the corresponding entry in the copy mapping table (310) uses free space in the modification space region of the volume (312) to store the data block (314).

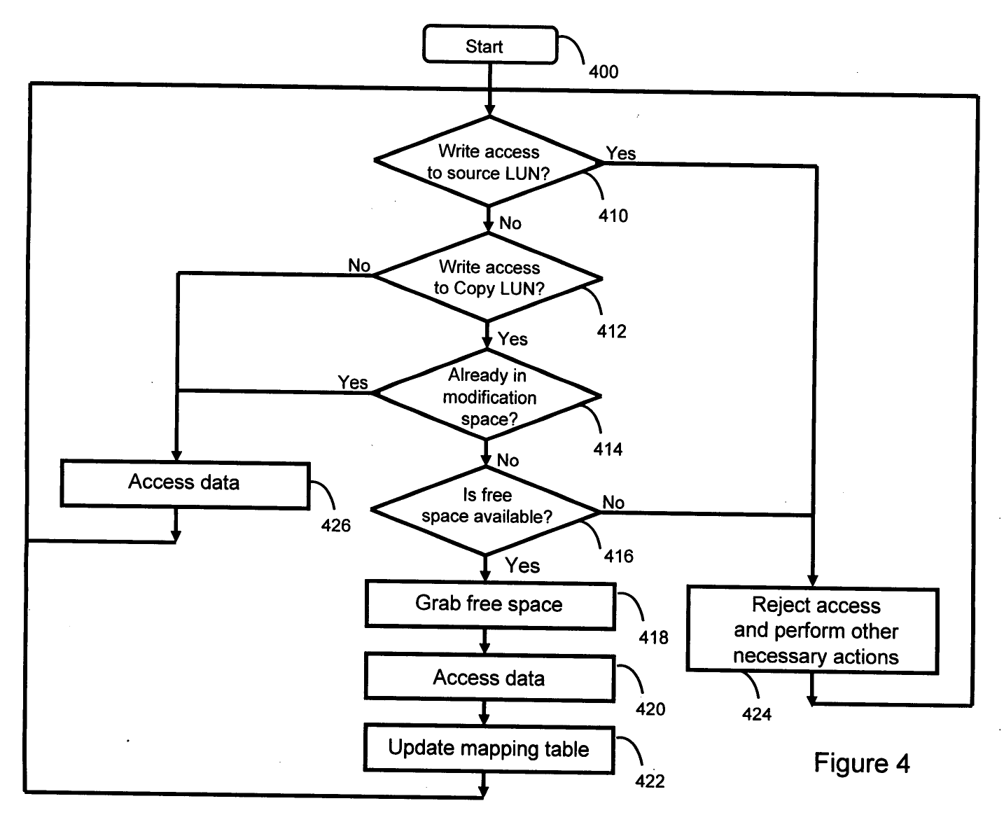

As shown in flowchart form in FIG. 4, when a request for writing into a block is received, the storage system detects if the write is to a point-in-time source LUN (block 410). If that is the case, the access is rejected (block 424) because the invention does not allow the source LUN to be modified. If not, then the request is checked to see if it is to a point-in-time-copy LUN (block 412). If that is not the case, then this is an access which can proceed without further inspection (block 426). If that is the case, the storage system first consults the mapping table (block 414). If the entry for the block being accessed shows that the block is stored in the modification space for that copy, the new data is written into the corresponding location (block 426). If the corresponding entry shows that the block is being accessed through the original block in the source LUN, then there is a need to find a place for storing the block in the modification space. To do so, the list of free blocks for that copy is consulted to see if required free space is available (block 416). If there is no space for accommodating the write request, the write request is denied and appropriate actions are taken (block 424). For example, a message can be sent to the system administrator informing the administrator of lack of space. In another embodiment, the copy is marked as unusable and all further accesses to the copy are rejected. In yet another embodiment, accesses to the copy volume are serviced as long as they do not require any new storage space. If free space for accommodating the write request is available, the necessary block(s) are taken out of the free list (block 418), data is stored in those blocks (block 420), and the mapping table is updated such that it reflects the changes (block 422).

The present invention improves the implementation of point-in-time copy operations. By providing a dedicated space for each copy (called modification space in this manuscript) storage space need not be managed as a global entity where each volume's block could be stored in any available location. Furthermore, by making the source volume a read only volume, scalability of the proposed copy operation improves significantly. If this restriction is not enforced, when a block in source volume is modified, the storage system needs to find free space in modification spaces for each copy volume and copy the original block into them one by one and then update the mapping tables for all copy volumes. This requirement puts a restrictive upper bound on the number of copy volumes any source volume can support. By marking a source volume read only as soon as the first copy volume from the source is created, such a requirement is eliminated. As shown in FIG. 4, each access to source or copy volumes can be evaluated and executed, if allowed, very easily.

A copy volume can be deleted. Each source volume keeps a counter of the number of copies it supports. Each time a copy of the source is deleted the copy counter is decremented. When the counter reaches zero, the source volume is marked as a regular volume and not a source volume anymore. This removes the read-only restriction applied to source volumes and the content of the volume can be modified. As soon as a copy is created from a volume, the volume is marked as a source volume and the value of the copy counter is set to one for the first copy and is incremented each time a new copy is created.

Thus, as shown above, the present invention provides a new approach for creating point-in-time copies of storage volumes which are useful in many environments. In particular the present invention is suitable for use with provisioning environments. In such environments, one or more golden images containing operating system and applications used by system users are created. Depending on the number and type of users, the system loads the golden images that are used to create multiple copies in a time and space efficient manner. These copies are then used for provisioning servers.

While the invention has been described in terms of preferred embodiments, those skilled in the art will recognize that the invention can be practiced with modification within the spirit and scope of the appended claims.

What is claimed is:

1. A computer system for maintaining a virtual point-in-time copy of source data, said system comprising:
a source storage unit mapping table adapted to maintain pointers to said source data; and
at least one target storage unit mapping table adapted to maintain pointers to said source data and pointers to modification data,
wherein said target storage unit mapping table is identical to said source storage unit mapping table except where pointers in said target storage unit mapping table point to said modification data in place of corresponding source data.

2. The system in claim 1, wherein, over time, said target storage unit mapping table maintains a unique virtual copy of said source data through a unique combination of pointers that point to portions of said source data and portions of said modification data.

3. The system in claim 1, wherein said pointers comprise one of direct pointers and indirect pointers.

4. The system in claim 1, further comprising a modification space that is adapted to maintain said modification data.

5. The system in claim 4, further comprising a list of free blocks of storage that are available as said modification space.

6. The system in claim 1, wherein said source storage unit mapping table includes pointers to locations on physical storage devices within a source storage unit that maintains said source data.

7. The system in claim 1, wherein said source storage unit mapping table and said target storage unit mapping table each comprise one of:
a mapping table of pointers;
a mapping table of flags; and
a linked list with hashing tables.

8. A computer system for maintaining a virtual point-in-time copy of source data, said system comprising:
a source storage unit comprising at least one physical storage device;
a source storage unit mapping table adapted to maintain pointers to said source data within said source storage unit;
at least one target storage unit comprising a target storage unit mapping table, wherein said target storage unit mapping table is adapted to maintain pointers to said source data within said source storage unit and pointers to modification data maintained within a modification space,
wherein said target storage unit mapping table is identical to said source storage unit mapping table except where pointers in said target storage unit mapping table point to said modification data in place of corresponding source data.

9. The system in claim 8, wherein, over time, said target storage unit mapping table maintains a unique virtual copy of said source data through a unique combination of pointers that point to portions of said source data and portions of said modification data.

10. The system in claim 8, wherein said pointers comprise one of direct pointers and indirect pointers.

11. The system in claim 8, further comprising a list of free blocks of storage that are available as said modification space.

12. The system in claim 8, wherein said source storage unit mapping table includes pointers to locations on said physical storage device within said source storage unit.

13. The system in claim 8, wherein said source storage unit mapping table and said target storage unit mapping table each comprise one of:
a mapping table of pointers;
a mapping table of flags; and
a linked list with hashing tables.

14. A method of creating and maintaining a virtual point-in-time copy of source data stored within a source storage unit, said method comprising:
receiving a request to create a point-in-time copy of said source data;
instead of creating said copy of said source data, creating a target storage unit mapping table, wherein said target storage unit mapping table contains pointers to said source data;
maintaining a modification space, wherein said modification space is associated with said target storage unit, and wherein said modification space only stores changes to said source data that are unique to said target storage unit; and
modifying said target storage unit mapping table as data is written to said modification space, wherein said modifying of said target storage unit mapping table redirects corresponding pointers in said target storage unit mapping table from said source data to said modification space.

15. The method in claim 14, wherein, over time, said target storage unit mapping table maintains a unique copy of said source data for said target storage unit through a unique combination of pointers that point to portions of said source data and portions of said modification space.

16. The method in claim 14, wherein said pointers comprise one of direct pointers and indirect pointers.

17. The method in claim 14, further comprising establishing said modification space.

18. The method in claim 14, wherein said source storage unit mapping table includes pointers to locations on physical storage devices within said source storage unit.

19. The method in claim 14, wherein said source storage unit mapping table and said target storage unit mapping table each comprise one of:
a mapping table of pointers;
a mapping table of flags; and
a linked list with hashing tables.

20. A method of creating and maintaining a virtual point-in-time copy of source data stored within a source storage unit, said method comprising:
receiving at least one request to create a point-in-time copy of said source data;
marking said source storage unit as a source volume, wherein when said source storage unit is marked as a source volume, it cannot be modified;
instead of creating said copy of said source data, creating a target storage unit mapping table, wherein said target storage unit mapping table contains pointers to said source data;
maintaining a modification space, wherein said modification space is associated with said target storage unit, and wherein said modification space only stores changes to said source data that are unique to said target storage unit;
modifying said target storage unit mapping table as data is written to said modification space, wherein said modifying of said target storage unit mapping table redirects corresponding pointers in said target storage unit mapping table from said source data to said modification space; and
deleting at least one target storage unit, wherein if no target storage units refer to said source storage unit, marking said source storage unit as a regular volume, wherein when said source storage unit is marked as a regular volume, it can be modified.

21. The method in claim 20, wherein, over time, said target storage unit mapping table maintains a unique copy of said source data for said target storage unit through a unique combination of pointers that point to portions of said source data and portions of said modification space.

22. The method in claim 20, wherein said pointers comprise one of direct pointers and indirect pointers.

23. The method in claim 20, further comprising maintaining a list of free blocks of storage that are available as said modification space.

24. The method in claim 20, wherein said source storage unit mapping table includes pointers to locations on physical storage devices within said source storage unit.

25. The method in claim 20, wherein said source storage unit mapping table and said target storage unit mapping table each comprise one of:
a mapping table of pointers;
a mapping table of flags; and
a linked list with hashing tables.

26. A service of creating and maintaining a virtual point-in-time copy of source data stored within a source storage unit, said service comprising:
receiving a request to create a point-in-time copy of said source data;
instead of creating said copy of said source data, creating a target storage unit mapping table, wherein said target storage unit mapping table contains pointers to said source data;
maintaining a modification space, wherein said modification space is associated with said target storage unit, and wherein said modification space only stores changes to said source data that are unique to said target storage unit; and
modifying said target storage unit mapping table as data is written to said modification space, wherein said modifying of said target storage unit mapping table redirects corresponding pointers in said target storage unit mapping table from said source data to said modification space.

27. The service in claim 26, wherein, over time, said target storage unit mapping table maintains a unique copy of said source data for said target storage unit through a unique combination of pointers that point to portions of said source data and portions of said modification space.

28. The service in claim 26, wherein said pointers comprise one of direct pointers and indirect pointers.

29. The service in claim 26, further comprising establishing said modification space.

30. The service in claim 26, wherein said source storage unit mapping table includes pointers to locations on physical storage devices within said source storage unit.

31. The service in claim 26, wherein said source storage unit mapping table and said target storage unit mapping table each comprise one of:
a mapping table of pointers;
a mapping table of flags; and
a linked list with hashing tables.

32. A program storage device readable by machine, tangibly embodying a program of instructions executable by the machine to perform a method of:
creating and maintaining a virtual point-in-time copy of source data stored within a source storage unit, said method comprising:
receiving at least one request to create a point-in-time copy of said source data;
marking said source storage unit as a source volume, wherein when said source storage unit is marked as a source volume, it cannot be modified;
instead of creating said copy of said source data, creating a target storage unit mapping table, wherein said target storage unit mapping table contains pointers to said source data;
maintaining a modification space, wherein said modification space is associated with said target storage unit, and wherein said modification space only stores changes to said source data that are unique to said target storage unit;
modifying said target storage unit mapping table as data is written to said modification space, wherein said modifying of said target storage unit mapping table redirects corresponding pointers in said target storage unit mapping table from said source data to said modification space; and
deleting at least one target storage unit, wherein if no target storage units refer to said source storage unit, marking said source storage unit as a regular volume, wherein when said source storage unit is marked as a regular volume, it can be modified.

33. The program storage device in claim 32, wherein, over time, said target storage unit mapping table maintains a unique copy of said source data for said target storage unit through a unique combination of pointers that point to portions of said source data and portions of said modification space.

34. The program storage device in claim 32, wherein said pointers comprise one of direct pointers and indirect pointers.

35. The program storage device in claim 32, wherein, over time, said target storage unit mapping table maintains a unique copy of said source data for said target storage unit through a unique combination of pointers that point to portions of said source data and portions of said modification space.

36. The program storage device in claim 32, wherein said pointers comprise one of direct pointers and indirect pointers.

37. The program storage device in claim 32, wherein said method further comprises establishing said modification space.

38. The program storage device in claim 32, wherein said source storage unit mapping table includes pointers to locations on physical storage devices within said source storage unit.

39. The program storage device in claim 32, wherein said source storage unit mapping table and said target storage unit mapping table each comprise one of:
a mapping table of pointers;
a mapping table of flags; and
a linked list with hashing tables.
